(19) United States
(12) Patent Application Publication
(10) Pub. No.: US 2014/0216942 A1
(43) Pub. Date: Aug. 7, 2014

(54) Carbon-Metal Thermal Management Substrates

(71) Applicant: Applied Nanotech Holdings, Inc, Austin, TX (US)

(72) Inventors: Nan Jiang, Austin, TX (US); Zvi Yaniv, Austin, TX (US)

(73) Assignee: Applied Nanotech Holdings, Inc., Austin, TX (US)

(21) Appl. No.: 14/343,220

(22) PCT Filed: Sep. 20, 2012
(86) PCT No.: PCT/US2012/056241

§ 371 Date: Mar. 6, 2014

Related U.S. Application Data
(60) Provisional application No. 61/537,160, filed on Sep. 21, 2011.

(51) Int. Cl. C23C 28/02; B23K 31/02

(52) U.S. Cl. CPC C23C 28/02; B23K 31/02
USPC 205/159; 228/176

(57) ABSTRACT

A method of manufacturing a thermal management hybrid article includes electroplating a copper layer on a graphitic layer, adhering the copper-plated graphitic layer to a plate of aluminum with a nano-copper paste to form a substrate, heating the substrate in a forming gas at a temperature less than 500° C. to melt to recrystallize the nano-copper paste, and cooling the substrate after the heating. A method of manufacturing a thermal management hybrid article includes electroplating a copper layer on a graphitic layer, electroplating copper on a plate of aluminum, and soldering the copper-plated layer on the graphitic layer to the copper-plated plate of aluminum. A method of manufacturing a thermal management hybrid article also includes electroplating a copper layer on a graphitic layer and immersing the copper-plated graphitic layer in molten aluminum to cast the an aluminum layer on the copper layer.

This application claims priority to U.S. Provisional Application Ser. No. 61/537,160, which is hereby incorporated by reference herein.

### TECHNICAL FIELD

The present invention relates in general to thermal management devices, and in particular to a composite material for thermal management devices.

### BACKGROUND INFORMATION

Thermal management materials with high thermal conductivity, high thermal diffusivity, machineability, low coefficient of thermal expansion (CTE) at low cost are desirable. For example, carbon based materials, such as graphite and graphene, typically have a number of excellent properties including high thermal conductivity, high thermal diffusivity, low CTE, and light-weight, which are highly desired for power electronics applications as heat transfer substrates. However, graphitic materials have relatively low mechanical strength, which limits their applications.

### SUMMARY

Embodiments disclosed herein combine a carbon plate, such as, but not limited to a graphite plate, and a metal plate, such as, but not limited to an aluminum plate, together to form an architecture of a graphite-aluminum based hybrid substrate. This kind of hybrid substrate exhibits super thermal properties of graphite and, meanwhile, possesses a sufficient mechanical robustness due to assembling the substrate with a robust metal plate.

The metal plate material may include a number of different types of materials. And the carbon plates may include graphite plates, and carbon/metal composite plates. An embodiment of this invention is to use aluminum and graphitic materials.

### BRIEF DESCRIPTION OF THE DRAWINGS

FIG. 1 illustrates a graphite-aluminum based substrate fabricated by an aluminum casting method.

FIG. 2 illustrates a graphite-aluminum based substrate fabricated with the use of nano-Cu paste.

FIG. 3 illustrates a graphite-aluminum based substrate fabricated by a soldering approach.

### DETAILED DESCRIPTION

Generally, aluminum (Al) has poor adhesion with graphitic materials, and it cannot be directly attached onto a graphite surface unless a high-pressure impregnation (high-pressure casting) method is used, which is very costly. However, aluminum can be mounted on a copper (Cu) plated graphite substrate, since this involves a metal-to-metal attachment. Hereinafter are described a number of approaches such as but not limit to:

### Casting Al on a Cu-Plating-Layer/Graphite

Step 1: Plating Cu (e.g., approximately 10-15 μm) on graphite.

An electroplating method is used to coat a Cu layer onto a graphite surface; the plating procedure is as follow: (1) ultrasonically clean graphite and Cu plates with acetone (e.g., approximately 5-10 minutes) to remove any surface contamination; (2) bake the graphite and Cu plates (e.g., approximately 60-80° C. for 10 min); (3) insert the Cu and graphite plates into an electroplating bath (e.g., wherein the electrolyte solution contains: 200 g CuSO₄.5H₂O+25.0 mL concentrated H₂SO₄+1.00 L deionized water); (4) clip the positive lead of a DC power supply to the copper plate (anode) and the negative lead to the graphite plate (cathode); (5) apply a voltage (e.g., approximately 4-6 V) on the Cu and graphite plates (e.g., for approximately 5-60 minutes) to complete the. Cu plating; (6) remove the. Cu-plated graphite substrate from the plating bath, rinse it by deionized water, and dry it (e.g., in a baking oven at approximately 60° C. for 10 minutes).

Step 2: Insert the Cu-plated graphite substrate into a molten Al bath.

(1) Insert Al blocks (e.g., approximately 1 kg) into a steel mold and heat the mold (e.g., approximately 700-750° C. using an electrical heater) to melt the Al blocks; (2) insert the Cu-plated graphite substrate into the molten bath; (3) maintain immersion of the Cu-plated graphite substrate in the molten bath e.g., for approximately 5-10 minutes at 700-750° C.), and then cool the steel mold (e.g., by switching off the electrical heater).

Step 3: After cooling, the ingot is removed, wherein Al is now cast on the Cu surface. Since Al has very poor wettability and adhesion to graphite but it has strong adhesion to Cu, the Al is only cast onto the Cu plating layer side.

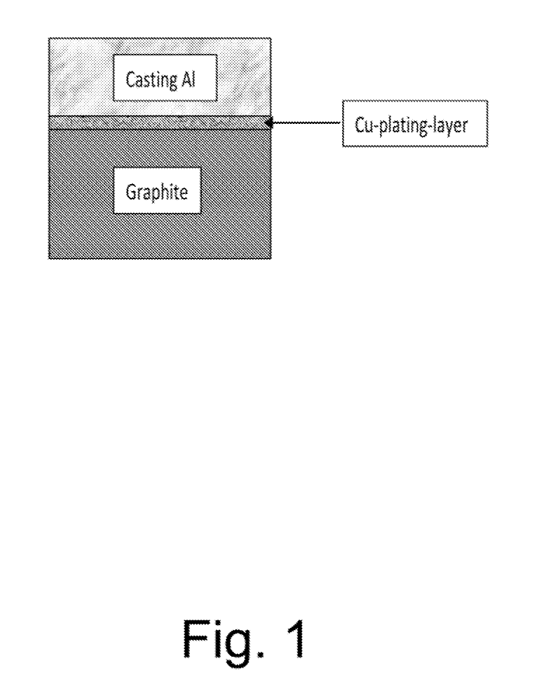

Step 4: The ingot may be sliced to obtain each Al/Cu-plating-layer/graphite substrate. An example of this substrate is shown in FIG. 1.

The thickness of the aluminum may be controlled either during these processes to provide a specific desired thickness or a specified thickness may be accomplished during post-processing mechanical methods, such as grinding, lapping, or polishing down the aluminum to a desired thickness.

### Using a Nano-Cu Paste

A nano-Cu paste may be melted and re-crystallized below 500° C. Since this temperature is much lower than the melting point of aluminum (approximately 660° C. the nano-Cu paste may be used as a metallic adhesive to adhere the aluminum to the Cu-plated graphite substrate. Such a copper nano-paste may comprise 20-50 nm Cu nanoparticles and low boiling point organic additives and dispersants. Examples of such materials are disclosed in U.S. Published Patent Application Nos. 2008/0286488, 2010/0000762, and 2009/0242854, which are hereby incorporated by reference herein.

Step 1: Plating Cu (e.g., approximately 10-150 μm) on a graphite substrate, wherein the Cu plating procedure is similar to the process described above.

Step 2: Adhere an Al plate onto the Cu-plated graphite substrate using nano-Cu paste. The may be performed by (1) printing the nano-Cu paste onto the Cu surface of the Cu-plated graphite substrate. The printing method may be screen print, drawdown printing, or hand printing; (2) attaching the Al plate onto the nano-Cu paste layer.

Step 3: Heating the resultant substrate in a forming gas (e.g., at an approximate temperature less than 500° C. (e.g. 450° C.) for a certain time (e.g., 30 minutes).

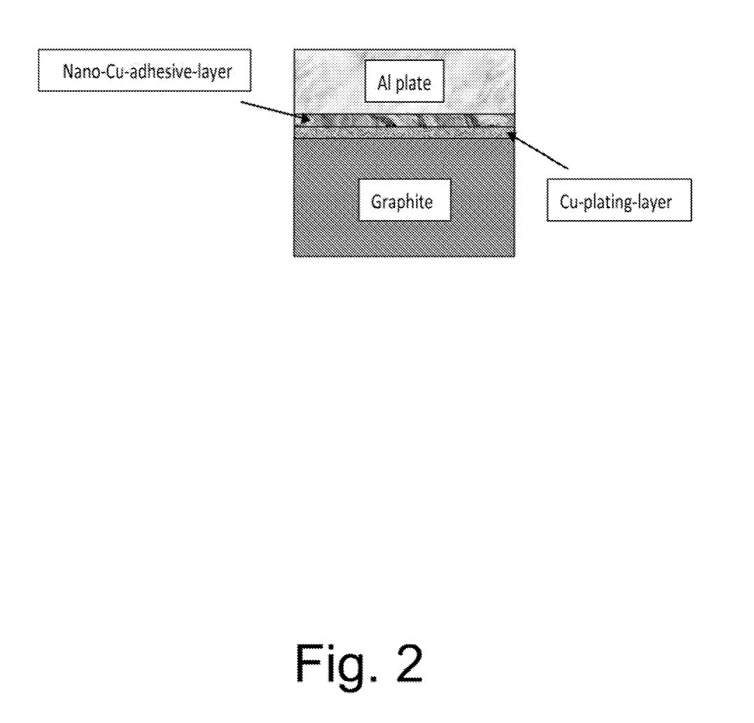

Step 4: Cooling and obtaining the Al/nano-Cu-adhesive/Cu-plating-layer/graphite substrate. An example of this substrate is shown in FIG. 2.

### Using a Soldering Technique

Step 1: Plating Cu (e.g., approximately 10-150 μm) on a graphite substrate, wherein the Cu plating procedure is similar to the process described above.

Step 2: Plating a Cu layer on a surface of an Al plate, which improves its soldering ability. An electroplating method may be used to coat the Cu layer onto the Al surface as follows: (1) ultrasonically clean the Al plate and the Cu plate (e.g., with acetone for approximately 5-10 minutes) to remove any surface contamination; (2) bake the Al and Cu plates (e.g., approximately 600° C. for 10 min); (3) insert the Al and Cu plates into an electroplating bath (e.g., wherein the electrolyte solution contains: 200 g CuSO₄.5H₂O+25.0 mL concentrated H₂SO₄+1.00 L deionized water); (4) clip the positive lead of a DC power supply to the copper (anode) and the negative lead to the Al plate (cathode); (5) apply a voltage (e.g., approximately 4-6 V) on the Cu and Al plates (e.g., for approximately 5-30 minutes) to complete the Cu plating; (6) remove the Al plate from the plating bath, rinse it with deionized water, and dry it (e.g., in a baking oven at approximately 60° C. for 10 minutes).

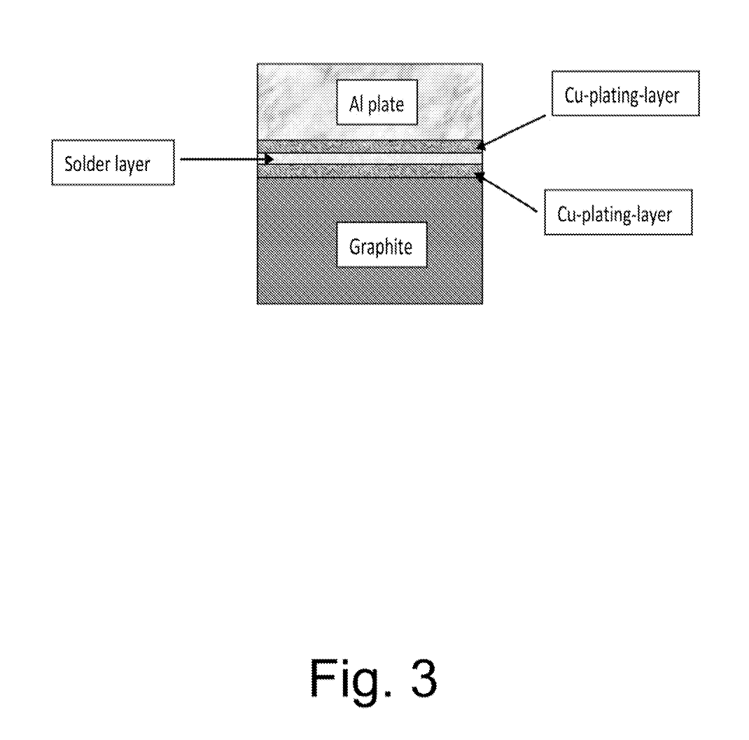

Step 3: Use tin-based solder materials to solder the two plates together, resulting in the Al/Cu-plating-layer/tin-solder-layer/Cu-plating-layer/graphite substrate. An example of this substrate is shown in FIG. 3.

As noted previously, the metal plates utilized are not limited to aluminum and may include other metals such as copper, nickel, gold, silver, tin, magnesium, zinc, brass, solders, and other alloys of metals with other metals as well as with dopants. The carbon plates are not limited to graphite, but may be other carbon-related materials such as diamond, carbon/Al composites, etc.

1. A method of manufacturing a thermal management hybrid article comprising:
electroplating a copper layer on a graphitic layer;
adhering the copper-plated graphitic layer to a plate of aluminum with a nano-copper paste to form a substrate;
heating the substrate in a forming gas at a temperature less than 500° C. to melt and recrystallize the nano-copper paste;
cooling the substrate alter the heating.

2. A method of manufacturing a thermal management hybrid article comprising:
electroplating a copper layer on a graphitic layer;
electroplating copper on a plate of aluminum;
soldering the copper-plated layer on the graphitic layer to the copper-plated plate of aluminum.

3. A method of manufacturing a thermal management hybrid article comprising:
electroplating a copper layer on a graphitic layer;
immersing the copper-plated graphitic layer in molten aluminum to cast the an aluminum layer on the copper layer.
